(19) United States
(12) Patent Application Publication
(10) Pub. No.: US 2026/0112135 A1
(43) Pub. Date: Apr. 23, 2026

(54) DYNAMIC GAUSSIAN SPLATTING LEARNED FROM HIERARCHICAL MOTION MODEL

(71) Applicant: InterDigital VC Holdings, Inc., Wilmington, DE (US)

(72) Inventors: Stefanos Pertigkiozoglou, Philadelphia, PA (US); Muhammad Asad Lodhi, Highland Park, NJ (US); Dong Tian, Boxborough, MA (US)

(21) Appl. No.: 18/923,318

(22) Filed: Oct. 22, 2024

(51) Int. Cl. G06T 19/20; G06T 7/246; G06T 15/20

(52) U.S. Cl. CPC G06T 19/20; G06T 7/246; G06T 15/20; G06T 2207/20016; G06T 2207/20084; G06T 2207/30244; G06T 2219/2016

(57) ABSTRACT

Some embodiments of a method may include: obtaining a reference 3D Gaussian frame, a camera position C, and a time t; extracting a multi-scale feature for each 3D Gaussian of one or more 3D Gaussians using a neural network block, wherein the multi-scale feature represents multi-scale spatial information about a dynamic object or scene; predicting 3D motion based on the multi-scale features and the time t; predicting a 3D Gaussian frame for time t by manipulating the one or more 3D Gaussians in a spatial domain based on the predicted 3D motion; and outputting the 3D Gaussian frame for time t.

### BACKGROUND

The present application is related to 3D reconstruction and rendering.

### SUMMARY

A first example method in accordance with some embodiments may include: obtaining a reference 3D Gaussian frame, a camera position C, and a time t; extracting a multi-scale feature for each 3D Gaussian of one or more 3D Gaussians using a neural network block, wherein the multi-scale feature represents multi-scale spatial information about a dynamic object or scene; predicting 3D motion based on the multi-scale features and the time t; predicting a 3D Gaussian frame for time t by manipulating the one or more 3D Gaussians in a spatial domain based on the predicted 3D motion; and outputting the 3D Gaussian frame for time t.

For some embodiment of the first example method, predicting the 3D motion includes performing a cross-attention process between the multi-scale spatial features and a query, the query includes a time embedding, and the cross-attention process includes: a multi-scale feature fusion, wherein, for each 3D Gaussian, spatial features are extracted and fused to create a sequence of per-Gaussian time tokens; and a cross-attention operation performed between the per-Gaussian time tokens and the time embedding for time t.

Some embodiments of the first example method may further include determining a rendered image based on the predicted 3D Gaussian frame at time t and the camera position C.

For some embodiment of the first example method, the 3D motion includes at least one of: a translation, a rotation, and a scaling.

Some embodiments of the first example method may further include rendering the 3D Gaussian frame for the camera position C and for the time t.

For some embodiment of the first example method, extracting the multi-scale feature includes using one or more convolutional neural networks (CNNs) to generate the multi-scale feature.

For some embodiment of the first example method, at least one of the one or more CNNs is a strided convolutional block.

For some embodiment of the first example method, extracting the multi-scale feature includes using one or more PointNet processes to generate the multi-scale feature.

Some embodiments of the first example method may further include using one or more subsampling and pooling processes in conjunction with the one or more PointNet processes to the multi-scale feature.

For some embodiment of the first example method, extracting the multi-scale feature includes using one or more Point Transformer processes to generate the multi-scale feature.

Some embodiments of the first example method may further include using one or more subsampling and pooling processes in conjunction with the one or more Point Transformer processes to the multi-scale feature.

For some embodiment of the first example method, predicting the 3D motion includes: transforming each of one or more multi-scale features into a respective set of level-dependent time tokens; fusing the one or more sets of level-dependent time tokens together to generate a set of per Gaussian time tokens; passing the set of per Gaussian time tokens through an attention layer process; and generating a Gaussian deforestation for time t by passing an output of the attention layer process through a multi-layer perceptron (MLP), wherein the predicted 3D motion includes the Gaussian deformation for time t.

A first example apparatus in accordance with some embodiments may include: a processor; and a memory storing instructions operative, when executed by the processor, to cause the apparatus to: obtain a reference 3D Gaussian frame, a camera position C, and a time t; extract a multi-scale feature for each 3D Gaussian of one or more 3D Gaussians using a neural network block, wherein the multi-scale feature represents multi-scale spatial information about a dynamic object or scene; predict 3D motion based on the multi-scale features and the time t; determine a 3D Gaussian frame for time t by manipulating the one or more 3D Gaussians in a spatial domain based on the predicted 3D motion; and output the 3D Gaussian frame for time t.

A second example method in accordance with some embodiments may include: extracting a multi-scale feature for each of one or more 3D Gaussians using a neural network block, predicting, for a time t, 3D motion based on the multi-scale features; determining a transformation of 3D Gaussian parameters between a reference 3D Gaussian frame and a 3D Gaussian frame at time t based on the predicted 3D motion; generating the 3D Gaussian frame at time t using the transformation of the 3D Gaussian parameters; and outputting the 3D Gaussian frame for time t.

For some embodiment of the second example method, generating the 3D Gaussian frame for time t includes manipulating the one or more 3D Gaussians in a spatial domain based on the predicted 3D motion.

For some embodiment of the second example method, each extracted multi-scale feature represents multi-scale spatial information about a scene.

Some embodiments of the second example method may further include determining a rendered image based on the generated 3D Gaussian frame at time t and the camera position C.

For some embodiment of the second example method, the 3D motion includes at least one of: a translation, a rotation, and a scaling.

For some embodiment of the second example method, wherein predicting the 3D motion includes performing a cross-attention between the multi-scale spatial features and a query, and wherein the query is generated by a time embedding process.

For some embodiment of the second example method, performing the cross-attention includes: fusing a multi-scale feature to obtain per-Gaussian time tokens, wherein fusing the multi-scale feature to obtain per-Gaussian time tokens includes: extracting spatial features for each 3D Gaussian; and fusing the extracted features to create a sequence of per-Gaussian time tokens; and performing a cross-attention operation between the per-Gaussian time tokens and the time embedding for time t.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1A is a system diagram illustrating an example set of interfaces for a system according to some embodiments.

FIG. 1B is a schematic plan view illustrating example relationships of extended reality scene description objects according to some embodiments.

FIG. 2 is a process diagram illustrating an example dynamic 3D Gaussian splatting overview process according to some embodiments.

FIG. 3 is a process diagram illustrating an example motion model with MLP according to some embodiments.

FIG. 4 is a process diagram illustrating an example motion model with per-Gaussian embedding according to some embodiments.

FIG. 5 is a process diagram illustrating an example multi-scale motion model according to some embodiments.

FIG. 6 is a process diagram illustrating an example multi-scale feature extraction process using CNN according to some embodiments.

FIG. 7 is a process diagram illustrating an example multi-scale feature extraction process using a PointNet++ algorithm according to some embodiments.

FIG. 8 is a process diagram illustrating an example multi-scale feature extraction process using a Point Transformer algorithm according to some embodiments.

FIG. 9 is a process diagram illustrating an example multi-scale feature fusion process according to some embodiments.

FIG. 10 is a process diagram illustrating an example cross attention block according to some embodiments.

FIG. 11 is a flowchart illustrating an example dynamic 3D Gaussian splatting process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . .” For brevity and clarity of presentation, this implied leading clause is not repeated ad nauseum in the detailed description.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

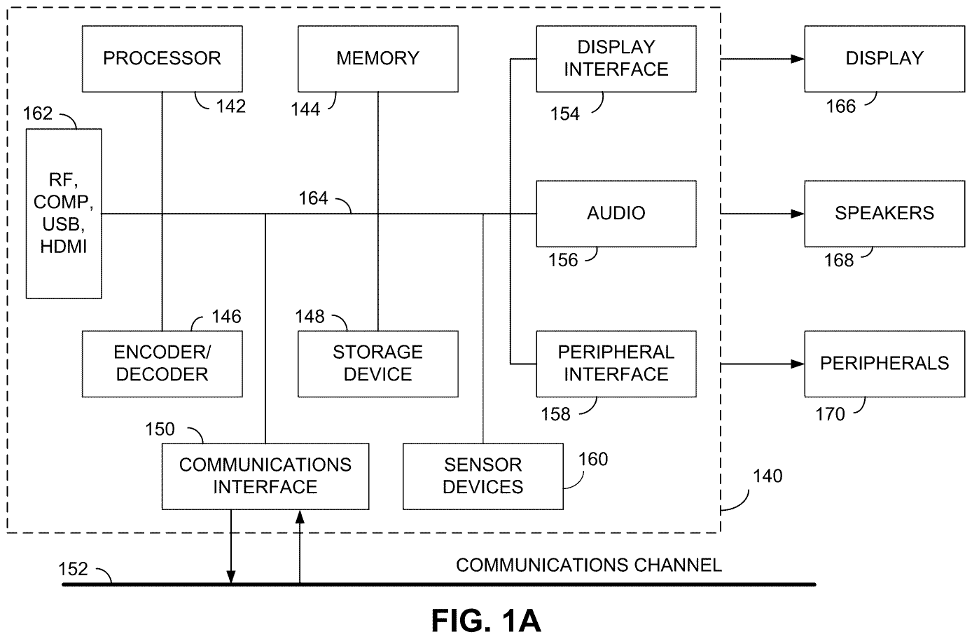

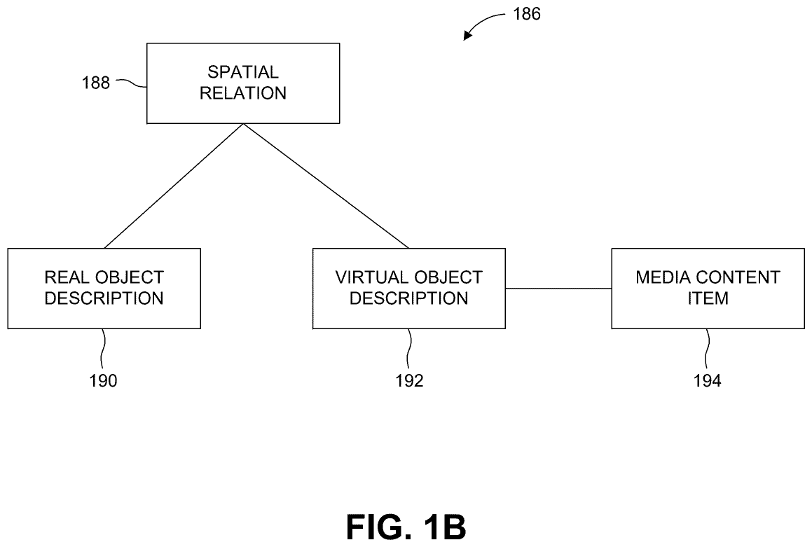

FIG. 1A is a system diagram illustrating an example set of interfaces for a system according to some embodiments. An extended reality display device, together with its control electronics, may be implemented using a system such as the system of FIG. 1A. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1A, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (12C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

### Scene Description Framework for XR

In some embodiments, examples disclosed herein may be used in the domain of rendering of extended reality scene description and extended reality rendering. For some embodiments, for example, the present application may be applied in the context of the formatting and the playing of extended reality applications when rendered on end-user devices such as mobile devices or Head-Mounted Displays (HMD). For some example embodiments, gITF material may be rendered in a 3D environment that is rendered through a 2D screen. The examples presented herein in accordance with some embodiments are not limited to XR applications.

In XR applications, a scene description is used to combine explicit and easy-to-parse description of a scene structure and some binary representations of media content.

In time-based media streaming, the scene description itself can be time-evolving to provide the relevant virtual content for each sequence of a media stream. For instance, for advertising purpose, a virtual bottle can be displayed during a video sequence where people are drinking.

This kind of behavior can be achieved by relying on the framework defined in the Scene Description for MPEG media document, Information technology-Coded representation of immersive media—Part 14: Scene Description for MPEG media, ISO/IEC DIS 23090-14:2021 (E). A scene update mechanism based on the JSON Patch protocol as defined in IETF RFC 6902 may be used to synchronize virtual content to MPEG media streams.

### Runtime Interactivity

FIG. 1B is a schematic plan view illustrating example relationships of extended reality scene description objects according to some embodiments. In this example, the scene graph 186 includes a description of a real object 190, for example ‘plane horizontal surface’ (that can be a table or the floor or a plate) and a description of a virtual object 192, for example an animation of a walking character. Scene graph node 192 is associated with a media content item 194 that is the encoding of data used to render and display the walking character (for example as a textured animated 3D mesh). Scene graph 186 also includes a node 188 that is a description of the spatial relation between the real object described in node 190 and the virtual object described in node 192. In this example, node 188 describes a spatial relation to make the character walk on the plane surface. When the XR application is started, media content item 194 is loaded, rendered and buffered to be displayed when triggered. When a plane surface is detected in the real environment by sensors (or a camera for some embodiments), the application displays the buffered media content item as described in node 188. The timing is managed by the application according to features detected in the real environment and to the timing of the animation. A node of a scene graph may also include no description and only play a role of a parent for child nodes.

XR applications are various and may apply to different context and real or virtual environments. For example, in an industrial XR application, a virtual 3D content item (e.g. a piece A of an engine) is displayed when a reference object (piece B of an engine) is detected in the real environment by a camera rigged on a head mounted display device. The 3D content item is positioned in the real-world with a position and a scale defined relatively to the detected reference object.

For example, in an XR application for interior design, a 3D model of a furniture is displayed when a given image from the catalog is detected in the input camera view. The 3D content is positioned in the real-world with a position and scale which is defined relatively to the detected reference image. In another application, some audio file might start playing when the user enters an area which is close to a church (being real or virtually rendered in the extended real environment). In another example, an ad jingle file may be played when the user sees a can of a given soda in the real environment. In an outdoor gaming application, various virtual characters may appear, depending on the semantics of the scenery which is observed by the user. For example, birds characters are suitable for trees, so if the sensors of the XR device detect real objects described by a semantic label ‘tree’, birds can be added flying around the trees. In a companion application implemented by smart glasses, a car noise may be launched in the user's headset when a car is detected within the field of view of the user camera, in order to warn him of the potential danger; Furthermore, the sound may be spatialized in order to make it arrive from the direction where the car was detected.

An XR application may also augment a video content rather than a real environment. The video is displayed on a rendering device and virtual objects described in the node tree are overlaid when timed events are detected in the video. In such a context, the node tree includes only virtual objects descriptions.

Example embodiments are described with reference to the scope of the MPEG-I Scene Description framework using the Khronos gITF extension mechanism, which supports additional scene description features, such as a node tree. However, the principles described herein are not limited to a particular scene description framework.

In an example embodiment, the gITF scene description is extended to support interactivity. The interactivity extension applies at the gITF scene level and is called MPEG_scene_interactivity. See the document ISO/IEC 23090-14, CDAM 2: Support for Haptics, Augmented Reality, Avatars, Interactivity, MPEG-I Audio, and Lighting, ISO/IEC JTC 1/SC 29/WG 03 N00797 (“MPEG Extension”).

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way which is consistent with the user context (environment, point of view, device, etc.). Scene graphs (such as the one proposed by Khronos/gITF and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand.

A User Equipment (UE) may correspond to any extended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

This disclosure belongs to the field of 3D reconstruction and rendering. For some embodiments, this application targets 3D Gaussian splatting related techniques. This field aims to develop tools for compression, analysis, interpolation, representation and understanding of 3D Gaussian splatting.

### 3D Gaussian Splatting

3D Gaussian splatting is an emerging technology used to efficiently represent and render 3D scenes. In the article Kerbl, Bernhard, et al., 3D Gaussian Splatting for Real-Time Radiance Field Rendering, 42:4 ACM TRANS. GRAPH. 139-1 (2023) (“Kerbl”), 3D Gaussian splatting was used to overcome common artifacts of point-based rendering techniques, while retaining their fast-rendering speeds. 3D Gaussian splatting utilizes 3D Gaussians as the primitives to represent the geometry and texture of a 3D scene. Specifically, 3D Gaussian splatting models a scene as a set of 3D Gaussians, which are defined by their means, covariances, opacity, and spherical harmonics that model their view dependent color, including RGB values.

While true to the underlying data, point cloud-based rendering may suffer from holes, causes aliasing, and is discontinuous. “Splatting” point primitives with an extent larger than a pixel (e.g., circular or elliptic discs, ellipsoids, or surfels) may address these issues.

A 3D Gaussian splatting format may be viewed as a new type of point cloud data. The means of Gaussians are point positions, and each point is associated with a new list of attributes. Covariances (which are point cloud attributes) together with point positions provide a complete description of surfaces for some embodiments. This situation is in contrast to naïve point clouds, in which the points are discrete samples on a surface, which is an incomplete representation of a surface. In addition, the three RGB values, opacity, and spherical harmonics (which are also point cloud attributes) significantly enhance the rendering quality.

While 3D Gaussian splatting shares the same projection model as the differential neural radiance field (NeRF) method (initially proposed in Mildenhall, Ben, et al., NeRF: Representing Scenes as Neural Radiance Fields for View Synthesis, 65:1 COMM. OF ACM 99-106 (2021) (“Mildenhall”), 3D Gaussian splatting may avoid the need to densely sample points over rays that project to a novel view. Instead, 3D Gaussians are projected directly into the image plane as 2D splats. By utilizing a differentiable projection and rasterization step, the Gaussian parameters may be optimized with only 2D supervision. As a result, a 3D representation may be optimized by minimizing the photometric loss between a rendered image and a ground truth view captured from the scene.

During optimization of Gaussian parameters, Kerbl designed a highly efficient tile-based rasterizer that allows for alpha-blending of anisotropic splats while respecting the order of the Gaussians in 3D space. Given a set of images and camera positions, this methodology allows a 3D representation of a scene to be done in a few minutes and at the same time allows rendering novel views in real time. This speed, along with the explicit nature of the Gaussian primitive that allows for easy geometric manipulation, makes 3D Gaussian splatting one of the commonly used differential rendering techniques in a large range of applications.

### Dynamic Gaussian Splatting

One of the most significant limitations of the original 3D Gaussian splatting is that 3D Gaussian splatting only addresses the challenges with static objects or scenes. 3D Gaussian splatting typically requires a set of images from different camera positions that are captured from static objects or scenes. This limits the use cases of such a technique, since many applications are interested in capturing dynamic scenes where objects move freely. For such cases, apart from modeling the static geometry and color of a scene, how this geometry and color change over time may be modeled to represent the motion of objects in the scene.

Dynamic Gaussian splatting is an extension of the original 3D Gaussian splatting and allows for simultaneous modeling of an object or scene and its transformation through time. Although dynamic Gaussian splatting poses a more challenging optimization problem for some embodiments, there are multiple recent developments that showcase promising results on extracting the motion of a dynamic scene using either: (1) multi-view video, or (2) monocular video. This application discusses, for some embodiments, a technique for modeling motion of a 3D Gaussian in both cases.

When modeling the motion of a 3D Gaussian, an expressive model that is able to describe the complex motions found in a dynamic scene may be used. While this expressivity is necessary for some embodiments, such expressivity may be a limiting factor to generalization of the model in new, unseen frames. Prior works may address this problem by applying additional losses, during optimization, that introduce implicit priors regarding possible motion in a scene. An example of such a constraint is the rigidity constraint, which introduces a loss that promotes neighboring Gaussians to move together as a rigid object. Although additional losses may be helpful, they may be less powerful because they are commonly hardcoded heuristics that cannot be adjusted during optimization given a specific scene or object to fit in.

### Problem Solved

3D Gaussian Splatting (3DGS) was initially proposed as a view synthesis technology suitable for static objects or scenes. However, many applications get involved with dynamic objects or scenes that are unable to be processed by 3DGS. Though 3DGS has been extended in several ways to accommodate dynamic objects or scenes, 3DGS is understood to continue to have more of a challenge with handling complex motions than simple/rigid motions. The problem to be addressed in this work is how to efficiently model and represent the motion in context of Gaussian splatting for high quality view synthesis for dynamic objects and scenes.

One way to extend 3D Gaussian Splatting (3DGS) for dynamic scenes is to extend the 3 dimensions for (x, y, z) to 4 dimensions for (x, y, z, t). This method is referenced as 4D Gaussian Splatting (4DGS) in Yang, Zeyu, et al., Real-Time Photorealistic Dynamic Scene Representation and Rendering with 4D Gaussian Splatting, INTERNATIONAL CONF. ON LEARNING REPRESENTATIONS (ICLR) (2023), arXiv preprint arXiv: 2310.10642 (“Yang 2”). Each 4D Gaussian has a fixed mean once the optimization of Gaussian splatting is finished. However, each Gaussian uses not only a 3-dimensional distribution to describe the geometrical property that is in the spatial domain but also an additional dimension to characterize the changes over a temporal direction. 4DGS is typically created to cover a dynamic scene for a given time window. Since no explicit motion field information is provided, a major disadvantage with 4DGS is a significant increase in the number of Gaussian parameters.

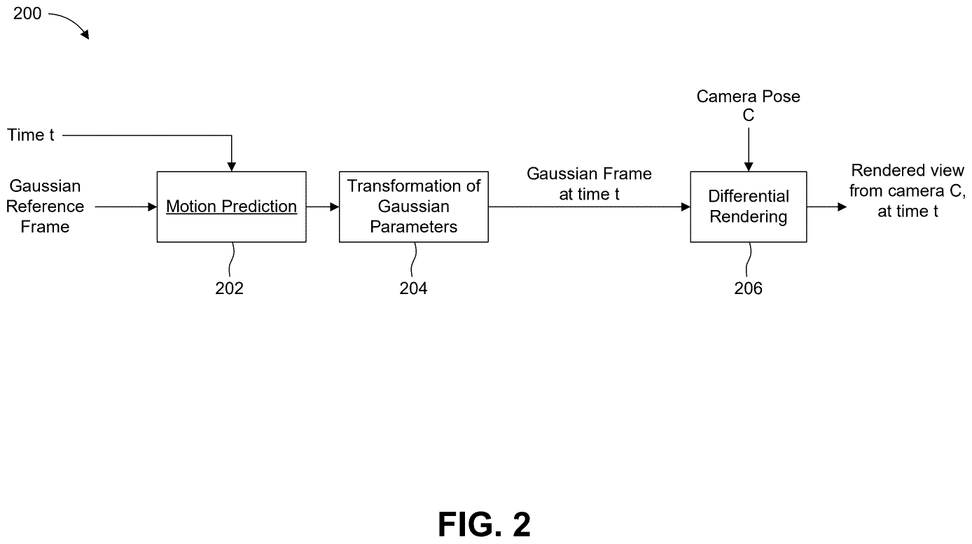

FIG. 2 is a process diagram illustrating an example dynamic 3D Gaussian splatting overview process according to some embodiments. To address the challenges of implicit motion modeling in 4DGS, FIG. 2 shows the general architectures used for dynamic 3D Gaussian splatting in articles Yang, Ziyi, et al., Deformable 3D Gaussians for High-Fidelity Monocular Dynamic Scene Reconstruction, IN PROC. OF THE IEEE/CVF CONF. COMP. VISION AND PATTERN RECOGNITION (CVPR) 20331-20341 (2024) (“Yang 1”) and Bae, Jeongmin, et al., Per-Gaussian Embedding-Based Deformation for Deformable 3D Gaussian Splatting, arXiv: 2404.03613 (2024) (“Bae”), where motions are explicitly modeled. This general design 200 takes as input the Gaussian parameters of a reference frame and a time t and uses a motion prediction model 202 to output the transformation of the 3D Gaussian parameters 204 from the reference frame to a frame at desired time t. After the predicted transformation is applied and the frame at time t is obtained, the 3D Gaussian splatting differential rendering technique 206 (proposed in Kerbl) may be used to create a novel view from a given camera position and orientation.

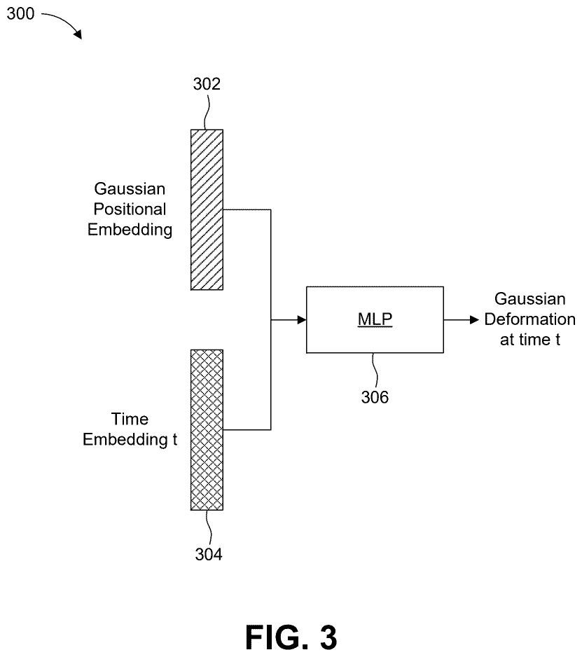

FIG. 3 is a process diagram illustrating an example motion model with MLP according to some embodiments. Specifically, the motion prediction model 300 that was utilized in Yang 1 is showed in FIG. 3. The motion prediction model 300 consists of an MLP 306 that takes as input the Gaussian positional embedding (encoding) 302 of each 3D Gaussian and the embedding of time t 304. The MLP 306 predicts how the location, orientation, and scale of each Gaussian transforms from the reference frame to the frame at time t.

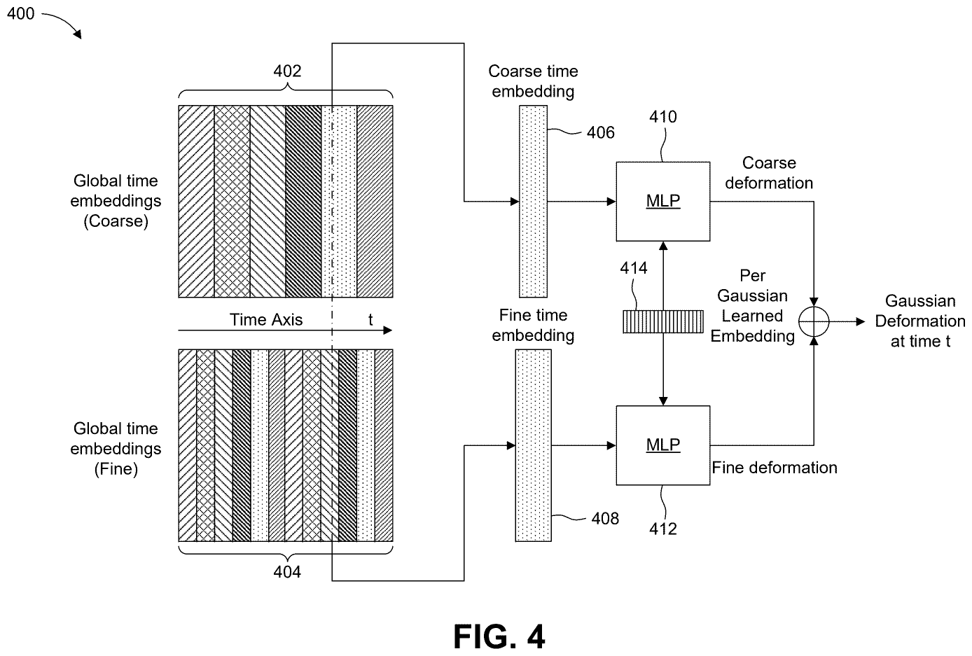

FIG. 4 is a process diagram illustrating an example motion model with per-Gaussian embedding according to some embodiments. FIG. 4 shows a similar process 400 as achieved in Bae. In Bae, global time features 402, 404 are extracted for given time t, respectively as coarse time embedding 406 and fine time embedding 408. The coarse time embedding 406 and a per-Gaussian learned embedding 414 are inputted into an MLP 410 to generate a coarse deformation. The fine time embedding 408 and a per-Gaussian learned embedding 414 are inputted into an MLP 412 to generate a fine deformation. The coarse deformation and the fine deformation are added together to generate a Gaussian Deformation at time t. While time features are distinguished into coarse 402 and fine 404, their distinction is based on the different time scales, with the coarser features changing slower as t changes compared to the finer features.

In this application, for some embodiments, a dual approach is used by introducing such implicit priors regarding the motions in a scene through the specific design of a motion model and not by the losses used during training. With these approaches, while implicit priors about the possible motions of objects are still introduced, the model is allowed to learn and adjust these constraints to a specific structure of an object or a scene. For example, while a rigid loss has a predefined shape of neighborhoods in which Gaussians should move as a rigid object, this approach may allow the model to learn a specific geometry of such neighborhoods given the training data. As understood, this fusion of multi-scale features extracted from a 3D Gaussian and used to model motion through time is a novel technique.

While, for some embodiments, this method uses the same general steps shown in FIG. 2, a distinctive factor is understood to lie in the specific design of the motion prediction model. The present approach incorporates spatial scale with the extraction of hierarchical per-Gaussian features. For each scale, the per-Gaussian features are extracted by the aggregation of information from a neighborhood of the corresponding size. A motion model design allows coarser features (extracted over larger neighborhoods) to be responsible for lower frequency parts of the motion of a large set of Gaussians. A motion model design also allows finer features (extracted over localized neighborhoods) to be responsible for refining the movements of each individual Gaussian by introducing higher frequency parts of the motion.

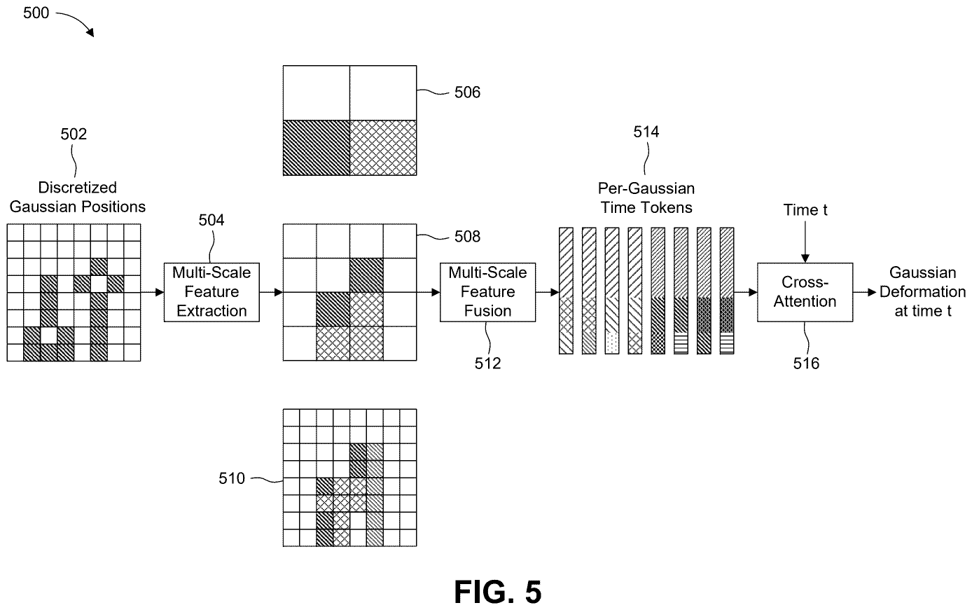

FIG. 5 is a process diagram illustrating an example multi-scale motion model according to some embodiments. The motion prediction model 500 shown in FIG. 5. includes three individual components: multi-scale spatial feature extraction process 504, multi-scale feature fusion process 512, and time conditioned cross-attention process 516

The multi-scale spatial feature extraction process 504 extracts, for each individual Gaussian (or discretized Gaussian portions 502), localized features by aggregating information from their neighboring Gaussians. By iteratively subsampling the space, localized features 506, 508, 510 of different spatial scales are extracted, which correspond to feature aggregation using different neighborhood sizes.

The multi-scale feature fusion process 512 is responsible for merging the per-Gaussian multi-scale features, extracted by the previous component, into a set of features refer to as per-Gaussian “time tokens” 514.

The time conditioned cross-attention process 516 outputs the final per-Gaussian transformation by performing cross-attention between the extracted time tokens and the time embedding of time t.

The details of the individual processes, along with their possible different embodiments are described below.

### Multi-Scale Feature Extraction

A feature extraction block's inputs are points corresponding to the Gaussian means of the reference frame. Each point is augmented with auxiliary features that correspond to the covariance and color parameters of each Gaussian, along with additional learned per-gaussian embeddings. The output of the feature extraction is per-gaussian features from scales ranging from 1 to N (with 1 being the finer scale and N being the coarser scale).

### CNN for Multi-Scale Feature Extraction

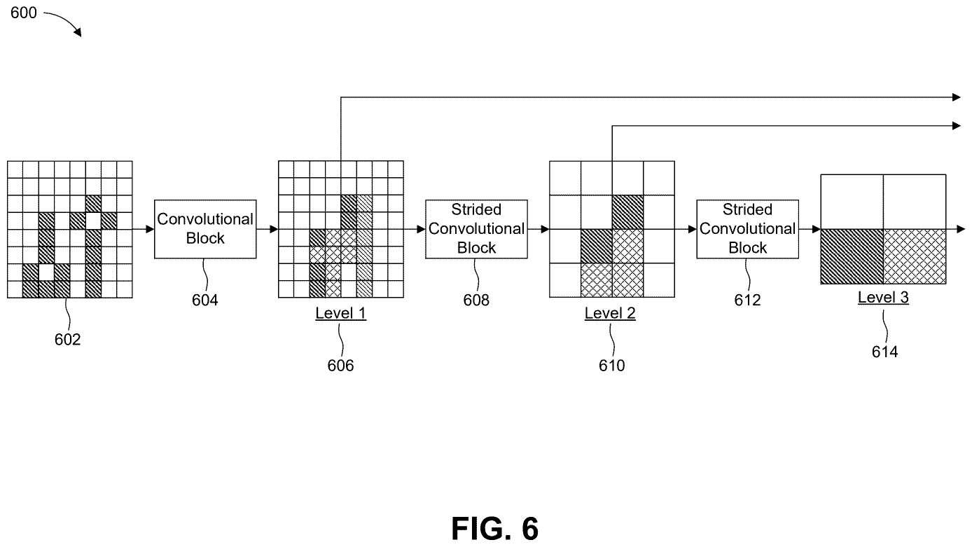

FIG. 6 is a process diagram illustrating an example multi-scale feature extraction process using CNN according to some embodiments. An example multi-scale feature extraction block 604 uses a Convolutional Neural Network (CNN), as shown in FIG. 6. A sequence of blocks 608, 612 contain a strided convolutional layer combined with a ReLU nonlinearity. Due to the properties of strided convolutions, each block outputs a subsampled version of the input point cloud 602. As a result, this example process 600 uses the intermediate outputs 606, 610, 614 of the CNN layers as features from multiple scales.

An example implementation of such convolutional neural network consists of three consecutive convolutional blocks 604, 608, 612 that include a convolutional layer followed by a ReLU. The first block 604 of the sequence contains a regular convolutional layer while the other two blocks 608, 612 contain strided convolutional layers with a stride equal to 2 in all (x, y, z) dimensions. In all three of the blocks 604, 608, 612, the convolutional layers have input and output channel dimension equal to 128 and a kernel of size 5×5×5.

The output of the feature extraction network described in this section includes a set of 3D grids that represent feature maps of different spatial resolutions. Given the output 3D grids, the per-Gaussian multi-scales feature(s) are obtained by using trilinear interpolation.

### Point-Based Multi-Scale Feature Extraction

While the CNN architecture presented above provides a fast and easy to optimize network, the process shown in FIG. 5 may have reduced expressivity due to the requirement of discretization of the Gaussian positions. Below, two point-based alternatives are shown that may provide increased expressivity with the downside of increased computational requirements.

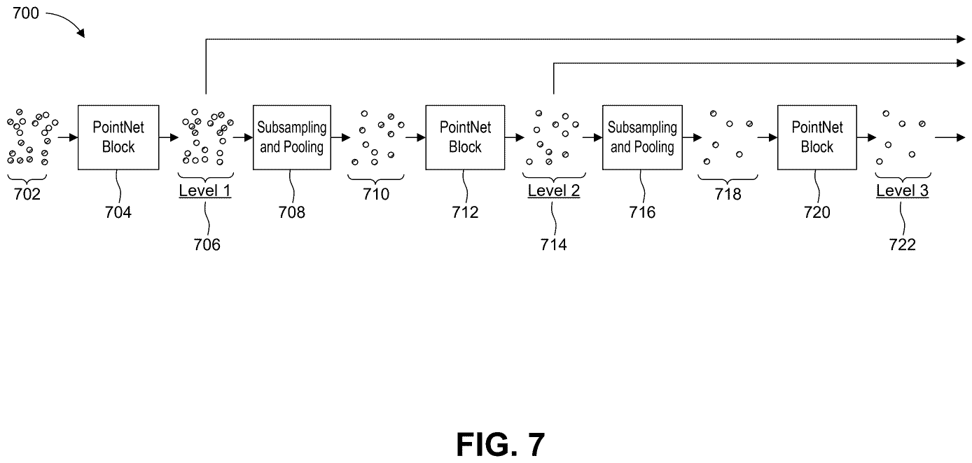

The first approach consists of a PointNet++ architecture (Qi, Charles, et al., PointNet++: Deep Hierarchical Feature Learning on Point Sets in a Metric Space, 30 ADV. NEURAL INFORMATION PROC. SYS. 1-10 (2017), arXiv: 1706.02413 (“Qi 1”)), as shown in FIG. 7. More precisely, consecutive PointNet blocks (Qi, Charles, et al., PointNet: Deep Learning on Point Sets for 3D Classification and Segmentation, IN PROC. OF IEEE CONF. COMP. VISION AND PATTERN RECOGNITION 652-660 (2017), arXiv: 1612.00593 (“Qi 2”) are applied to the input points to extract per-point features which then are pooled over a subsampled version of the input point-cloud. For the PointNet block, the same architecture as the one proposed in Qi 2 is followed, where an MLP is applied to the features of the individual points and the outputs are combined through a feature transformation.

The second approach uses a PointTransformer, which is proposed in Zhao, Hengshuang, et. al., Point Transformer, IN PROC. OF IEEE/CVF INTERNATIONAL CONF. COMP. VISION 16259-16268 (2021) (“Zhao”). Similar with the PointNet++ architecture, consecutive point-based feature processing blocks are followed by subsampling and pooling layers. The main difference in this implementation is that the point-based feature processing block is a transformer block. In the transformer block, a local attention operation is used, where each point attends to the features of the points in a local neighborhood.

FIG. 7 is a process diagram illustrating an example multi-scale feature extraction process using a PointNet++ algorithm according to some embodiments. An example implementation 700 of such a model includes an input set of point-based features 702 followed by 3 consecutive PointNet blocks 704, 712, 720 interspersed with subsampling and pooling layers 708, 716. The input and output features of all layers are set to be equal to 128. Each PointNet block 704, 712, 720 outputs a respective level of features 706, 714, 722. Each subsampling and pooling block 708, 716 outputs a respective set of points 710, 718 that are used as inputs to the next respective PointNet block 712, 720.

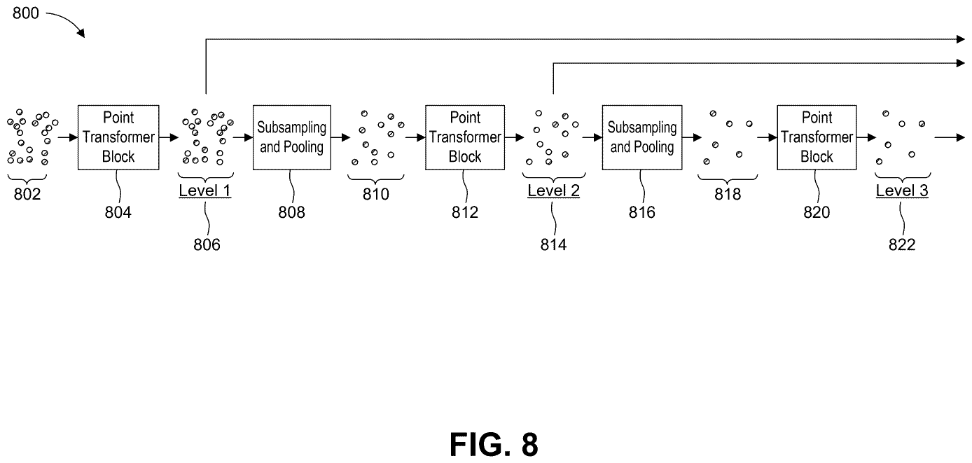

FIG. 8 is a process diagram illustrating an example multi-scale feature extraction process using a Point Transformer algorithm according to some embodiments. FIG. 8 shows an implementation 800 of this approach, which includes an input set of point-based features 702 followed by three consecutive transformer layers 804. 812. 820 interspersed with subsampling and pooling layers 808, 816. An example implementation of such a model uses layers with input and output channel dimensions equal to 128 and an attention operation where each point attends to the 15 nearest neighbors. Each Point Transformer block 804, 812, 820 outputs a respective level of features 806, 814, 822. Each subsampling and pooling block 808, 816 outputs a respective set of points 810, 818 that are used as inputs to the next respective Point Transformer block 812, 820.

Both approaches shown in FIGS. 7 and 8 and described above extract per-point features for subsampled versions of a point cloud. As a result, in the later layers of the feature extraction network, the per-point features are extracted only in a subset of the original Gaussians. In order to infer the multi-scale features of each Gaussian in all levels, interpolation layers are used to interpolate the per-point features given the feature of the neighboring points. These interpolation layers may be either a PointNet block or a transformer block. For the interpolation layers, features are interpolated from the 5 nearest neighbors.

### Multi-Scale Feature Fusion

The goal of the multi-scale feature fusion component is to combine the extracted per-gaussian features of each individual scale into a format that is appropriate for the following Time Conditioned Cross-Attention block. For some embodiments, the time conditioned cross-attention block requires as input a set of features, which are referred to as time tokens.

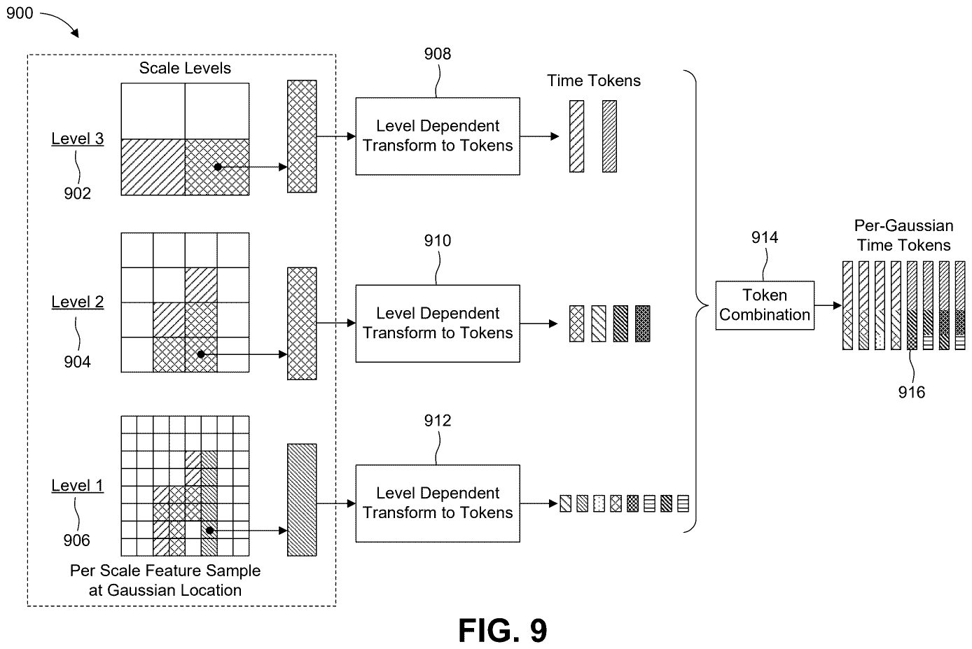

FIG. 9 is a process diagram illustrating an example multi-scale feature fusion process according to some embodiments. FIG. 9 shows an example feature fusion component 900. The inputs of the component are the per-Gaussian features 902, 904, 906 with dimension M extracted from different level scales ranging from 1 to N. For the visualization shown in FIG. 9, the input multi-scale features 902, 904, 906 are assumed to be extracted by a CNN block, which is described above. This choice is made only for visualization purposes since the multi-scale feature fusion block may be combined with point-based feature extraction blocks, which are also described above. An example implementation, shown in FIG. 9, uses M=128 and N=3. This component has two steps.

In step 1, each Gaussian at scale level k uses a learnable linear map to transform the M dimensional feature to 2^{k} features of dimension M/(2^{k}). As shown in FIG. 9, this methodology results in scale levels with a lower k to have a lower number of higher dimensional features. This methodology also results in scale levels with a higher k to have a higher number of low dimensional features. These distinct features of each level are referred to as tokens.

In step 2, the different scale level tokens are merged by repeating them at each level so that all levels have an equal number of tokens. This repeating is shown in FIG. 9 as a set of Level Dependent Transform to Tokens processes 908, 910, 912. More precisely, for scale level k, 2^{N-k} copies of each token are used. For the example, as shown in FIG. 9, if N=3, this means that, for level k=1, each feature token is repeated 4 times. For level k=2, each feature token is repeated 2 times, and for level k=3, the feature tokens are not repeated. The tokens from the different scales are concatenated (by a token combination block 914) to create 2\hat{ }N fused tokens that are the inputs to cross attention block, which is described below.

Cross Attention with Time Embedding

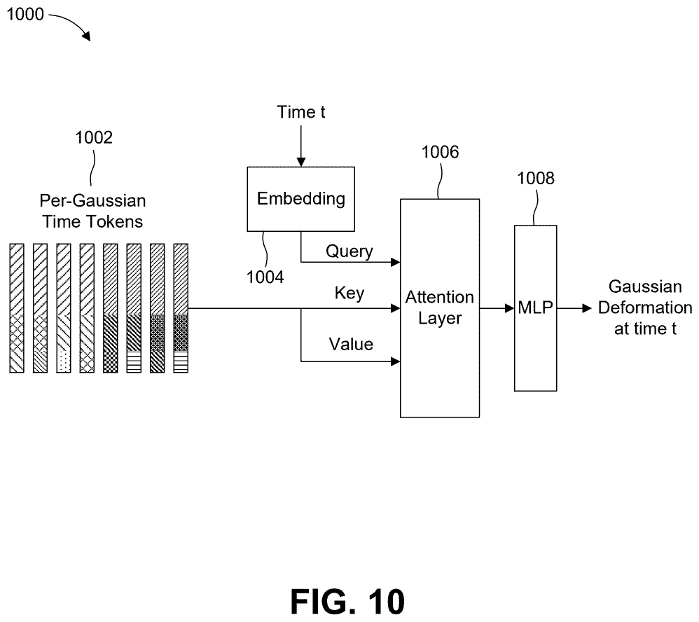

FIG. 10 is a process diagram illustrating an example cross attention block according to some embodiments. For some embodiments, the final component is a cross attention block, which outputs a transformation of the 3D Gaussian that maps them from a reference frame to a frame at time t. The cross attention block 1000, shown in FIG. 10, includes two steps.

In step 1, cross attention is performed between the time tokens produced by the multi-scale feature fusion and the embedding 1004 of time t.

In general, for some embodiments, the attention layer operation 1006 takes a query, a key, a value as inputs and combines them using Eq. 1:

$$Attention ( Q , K , V ) = softmax ( \frac{{QW}_{q} {W}_{k}^{T} {K}^{T}}{\sqrt{{d}_{k}}} ) ( {VW}_{v} ) \qquad ( 1 )$$

where Q is the query vector with a dimension d_{q}, K is the key vector with a dimension dₖ, V is the value vector with a dimension dᵥ and W_{q}, Wₖ, Wᵥ are learnable matrices with dimensions of (d_{q}×d), (dₖ×d), and (dᵥ×d). The key and value of the attention operation are the time tokens 1002 predicted for each Gaussian and the query of the attention is the embedding of time t. This embedding is described above for some embodiments.

In step 2, the output of the attention layer operation 1006 is inputted to an MLP 1008. The MLP 1008 produces the parameters of the transformation, which maps the 3D Gaussians from a reference frame to a frame at time t.

An example implementation of such a block uses a cross attention layer with dₖ and dᵥ equal to 112. Parameter d_{q} is equal to 20 if sinusoidal time embedding (shown below) is used. Parameter d_{q} is equal to 128 if learned time embedding (also shown below) is used. Parameter d is equal to 128. A 2-layer MLP is used with input, hidden, and output dimensions all being equal to 128.

### Sinusoidal Time Embedding

Given a sequence of frequencies w₁, w₂, . . . , wₗ, we construct the embedding of t as the vector vₜ=[cos(wₗt), sin(wₗt), cos(w₂t), sin(w₂t), . . . , cos(wₗt), sin(wₗt)] where cos, sin corresponds to the cosine and sine trigonometric functions accordingly. As shown in Tancik, Matthew, et al., Fourier Features Let Networks Learn High Frequency Functions in Low Dimensional Domains, 33 ADV. NEURAL INFORMATION PROC. SYS. 7537-7547 (2020) (“Tancik”), this lifting of the low-dimensional input into a higher dimension that contains multiple frequencies allows for simple neural networks to more easily learn high frequency functions. An example implementation of such an encoding sets the frequencies w₁, w₂, . . . , wₗ to be powers of 2, starting from 2 and ending at 1024, totaling 10 frequencies.

### Time Embedding

An extension of sinusoidal embedding allows the embedding of time t to be any arbitrary function of t. During optimization, such a function may be learned by a light-weighted MLP that takes as input a sinusoidal embedding and outputs the learned time embedding φ(t). Although the use of a learned time embedding provides additional expressivity since this use is a generalization of the embedding presented above, this use may also create a more challenging optimization problem. Thus, depending on the specific application, there is a tradeoff between expressivity of the motion model and the simplicity of the optimization. An example implementation of such a learned encoding uses a 2-layer MLP (with the input being the encoding presented above), a hidden layer of size 64, and an output of size 128.

This application provides an expressive method for modeling the motion of 3D Gaussian, used in dynamic Gaussian splatting. The method utilizes multi-scale local features to model the motion of each Gaussian. Some embodiments use a representation format that allows for features to be extracted from a coarse spatial scale to model the lower frequency motions of Gaussians over a large neighborhood while the more localized finer features to model the higher frequency parts of the motions. For each Gaussian, the extracted multi-scale features are fused to create a set of time tokens. These tokens are combined with time t, through a cross-attention operation, for the prediction of the transformation, which maps a reference frame to a frame at a specific time t. After the 3D Gaussians are transformed to their locations at time t, a rendering process may be used to produce a novel view at that time.

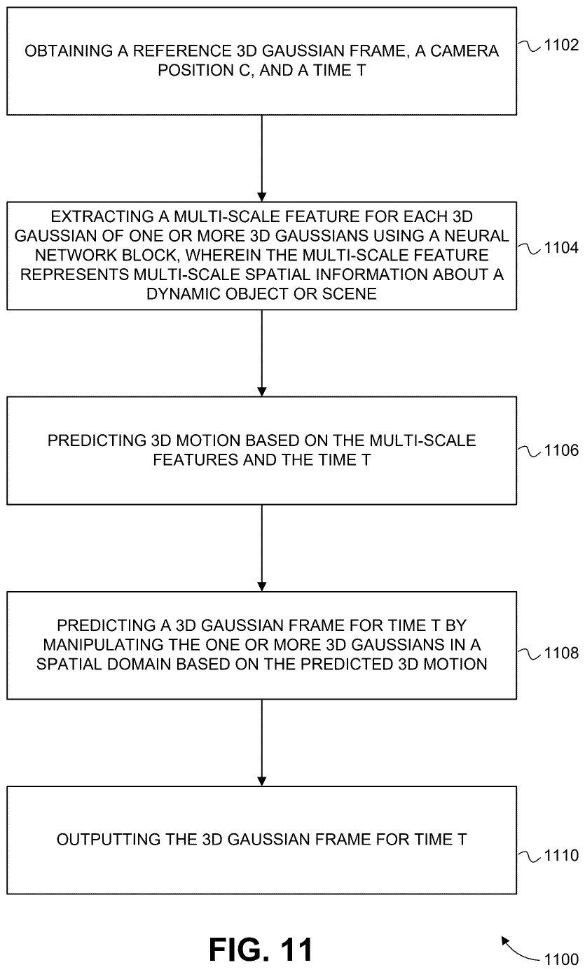

FIG. 11 is a flowchart illustrating an example dynamic 3D Gaussian splatting process according to some embodiments. For some embodiments, an example process 1100 may include obtaining 1102 a reference 3D Gaussian frame, a camera position C, and a time t. For some embodiments, the example process 1100 may further include extracting 1104 a multi-scale feature for each 3D Gaussian of one or more 3D Gaussians using a neural network block, wherein the multi-scale feature represents multi-scale spatial information about a dynamic object or scene. For some embodiments, the example process 1100 may further include predicting 1106 3D motion based on the multi-scale features and the time t. For some embodiments, the example process 1100 may further include predicting 1108 a 3D Gaussian frame for time t by manipulating the one or more 3D Gaussians in a spatial domain based on the predicted 3D motion. For some embodiments, the example process 1100 may further include outputting 1110 the 3D Gaussian frame for time t.

For some embodiments, a dynamic 3D Gaussian splatting process may include a method to obtain a dynamic Gaussian Splatting representation for a dynamic object or scene.

For some embodiments, a multi-scale feature is a feature that includes/summarizes information from several scales. For example, such scales may be spatial, temporal, and/or attribute (color) information or their combination. For some embodiments, a multi-scale spatial feature is a feature that includes/summarizes only spatial (geometry) information from several scales. For some embodiments, multi-scale spatial information is spatial (geometry) information from several scales.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: obtaining a reference 3D Gaussian frame, a camera position C, and a time t; extracting a multi-scale feature for each 3D Gaussian of one or more 3D Gaussians using a neural network block, wherein the multi-scale feature represents multi-scale spatial information about a dynamic object or scene; predicting 3D motion based on the multi-scale features and the time t; predicting a 3D Gaussian frame for time t by manipulating the one or more 3D Gaussians in a spatial domain based on the predicted 3D motion; and outputting the 3D Gaussian frame for time t.

For some embodiment of the first example method, predicting the 3D motion includes performing a cross-attention process between the multi-scale spatial features and a query, the query includes a time embedding, and the cross-attention process includes: a multi-scale feature fusion, wherein, for each 3D Gaussian, spatial features are extracted and fused to create a sequence of per-Gaussian time tokens; and a cross-attention operation performed between the per-Gaussian time tokens and the time embedding for time t.

Some embodiments of the first example method may further include determining a rendered image based on the predicted 3D Gaussian frame at time t and the camera position C.

For some embodiment of the first example method, the 3D motion includes at least one of: a translation, a rotation, and a scaling.

Some embodiments of the first example method may further include rendering the 3D Gaussian frame for the camera position C and for the time t.

For some embodiment of the first example method, extracting the multi-scale feature includes using one or more convolutional neural networks (CNNs) to generate the multi-scale feature.

For some embodiment of the first example method, at least one of the one or more CNNs is a strided convolutional block.

For some embodiment of the first example method, extracting the multi-scale feature includes using one or more PointNet processes to generate the multi-scale feature.

Some embodiments of the first example method may further include using one or more subsampling and pooling processes in conjunction with the one or more PointNet processes to the multi-scale feature.

For some embodiment of the first example method, extracting the multi-scale feature includes using one or more Point Transformer processes to generate the multi-scale feature.

Some embodiments of the first example method may further include using one or more subsampling and pooling processes in conjunction with the one or more Point Transformer processes to the multi-scale feature.

For some embodiment of the first example method, predicting the 3D motion includes: transforming each of one or more multi-scale features into a respective set of level-dependent time tokens; fusing the one or more sets of level-dependent time tokens together to generate a set of per Gaussian time tokens; passing the set of per Gaussian time tokens through an attention layer process; and generating a Gaussian deforestation for time t by passing an output of the attention layer process through a multi-layer perceptron (MLP), wherein the predicted 3D motion includes the Gaussian deformation for time t.

A first example apparatus in accordance with some embodiments may include: a processor; and a memory storing instructions operative, when executed by the processor, to cause the apparatus to: obtain a reference 3D Gaussian frame, a camera position C, and a time t; extract a multi-scale feature for each 3D Gaussian of one or more 3D Gaussians using a neural network block, wherein the multi-scale feature represents multi-scale spatial information about a dynamic object or scene; predict 3D motion based on the multi-scale features and the time t; determine a 3D Gaussian frame for time t by manipulating the one or more 3D Gaussians in a spatial domain based on the predicted 3D motion; and output the 3D Gaussian frame for time t.

A second example method in accordance with some embodiments may include: extracting a multi-scale feature for each of one or more 3D Gaussians using a neural network block, predicting, for a time t, 3D motion based on the multi-scale features; determining a transformation of 3D Gaussian parameters between a reference 3D Gaussian frame and a 3D Gaussian frame at time t based on the predicted 3D motion; generating the 3D Gaussian frame at time t using the transformation of the 3D Gaussian parameters; and outputting the 3D Gaussian frame for time t.

For some embodiment of the second example method, generating the 3D Gaussian frame for time t includes manipulating the one or more 3D Gaussians in a spatial domain based on the predicted 3D motion.

For some embodiment of the second example method, each extracted multi-scale feature represents multi-scale spatial information about a scene.

Some embodiments of the second example method may further include determining a rendered image based on the generated 3D Gaussian frame at time t and the camera position C.

For some embodiment of the second example method, the 3D motion includes at least one of: a translation, a rotation, and a scaling.

For some embodiment of the second example method, wherein predicting the 3D motion includes performing a cross-attention between the multi-scale spatial features and a query, and wherein the query is generated by a time embedding process.

For some embodiment of the second example method, performing the cross-attention includes: fusing a multi-scale feature to obtain per-Gaussian time tokens, wherein fusing the multi-scale feature to obtain per-Gaussian time tokens includes: extracting spatial features for each 3D Gaussian; and fusing the extracted features to create a sequence of per-Gaussian time tokens; and performing a cross-attention operation between the per-Gaussian time tokens and the time embedding for time t.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
obtaining a reference 3D Gaussian frame, a camera position C, and a time t;
extracting a multi-scale feature for each 3D Gaussian of one or more 3D Gaussians using a neural network block,
wherein the multi-scale feature represents multi-scale spatial information about a dynamic object or scene;
predicting 3D motion based on the multi-scale features and the time t;
predicting a 3D Gaussian frame for time t by manipulating the one or more 3D Gaussians in a spatial domain based on the predicted 3D motion; and
outputting the 3D Gaussian frame for time t.

2. The method of claim 1,
wherein predicting the 3D motion comprises performing a cross-attention process between the multi-scale spatial features and a query,
wherein the query comprises a time embedding, and
wherein the cross-attention process comprises:
a multi-scale feature fusion,
wherein, for each 3D Gaussian, spatial features are extracted and fused to create a sequence of per-Gaussian time tokens; and
a cross-attention operation performed between the per-Gaussian time tokens and the time embedding for time t.

3. The method of claim 1, further comprising determining a rendered image based on the predicted 3D Gaussian frame at time t and the camera position C.

4. The method of claim 1, wherein the 3D motion comprises at least one of: a translation, a rotation, and a scaling.

5. The method of claim 1, further comprising rendering the 3D Gaussian frame for the camera position C and for the time t.

6. The method of claim 1, wherein extracting the multi-scale feature comprises using one or more convolutional neural networks (CNNs) to generate the multi-scale feature.

7. The method of claim 6, wherein at least one of the one or more CNNs is a strided convolutional block.

8. The method of claim 1, wherein extracting the multi-scale feature comprises using one or more PointNet processes to generate the multi-scale feature.

9. The method of claim 8, further comprising using one or more subsampling and pooling processes in conjunction with the one or more PointNet processes to the multi-scale feature.

10. The method of claim 1, wherein extracting the multi-scale feature comprises using one or more Point Transformer processes to generate the multi-scale feature.

11. The method of claim 8, further comprising using one or more subsampling and pooling processes in conjunction with the one or more Point Transformer processes to the multi-scale feature.

12. The method of claim 1, wherein predicting the 3D motion comprises:
transforming each of one or more multi-scale features into a respective set of level-dependent time tokens;
fusing the one or more sets of level-dependent time tokens together to generate a set of per Gaussian time tokens;
passing the set of per Gaussian time tokens through an attention layer process; and
generating a Gaussian deforestation for time t by passing an output of the attention layer process through a multi-layer perceptron (MLP),
wherein the predicted 3D motion comprises the Gaussian deformation for time t.

13. An apparatus comprising:
a processor; and
a memory storing instructions operative, when executed by the processor, to cause the apparatus to:
obtain a reference 3D Gaussian frame, a camera position C, and a time t;
extract a multi-scale feature for each 3D Gaussian of one or more 3D Gaussians using a neural network block,
wherein the multi-scale feature represents multi-scale spatial information about a dynamic object or scene;
predict 3D motion based on the multi-scale features and the time t;
determine a 3D Gaussian frame for time t by manipulating the one or more 3D Gaussians in a spatial domain based on the predicted 3D motion; and
output the 3D Gaussian frame for time t.

14. A method comprising:
extracting a multi-scale feature for each of one or more 3D Gaussians using a neural network block,
predicting, for a time t, 3D motion based on the multi-scale features;
determining a transformation of 3D Gaussian parameters between a reference 3D Gaussian frame and a 3D Gaussian frame at time t based on the predicted 3D motion;
generating the 3D Gaussian frame at time t using the transformation of the 3D Gaussian parameters; and
outputting the 3D Gaussian frame for time t.

15. The method of claim 14, wherein generating the 3D Gaussian frame for time t comprises manipulating the one or more 3D Gaussians in a spatial domain based on the predicted 3D motion.

16. The method of claim 14, wherein each extracted multi-scale feature represents multi-scale spatial information about a dynamic object or scene.

17. The method of claim 14, further comprising determining a rendered image based on the generated 3D Gaussian frame at time t and the camera position C.

18. The method of claim 14, wherein the 3D motion comprises at least one of: a translation, a rotation, and a scaling.

19. The method of claim 14,
wherein predicting the 3D motion comprises performing a cross-attention between the multi-scale spatial features and a query, and
wherein the query is generated by a time embedding process.

20. The method of claim 19, wherein performing the cross-attention comprises:
fusing a multi-scale feature to obtain per-Gaussian time tokens,
wherein fusing the multi-scale feature to obtain per-Gaussian time tokens comprises:
extracting spatial features for each 3D Gaussian; and
fusing the extracted features to create a sequence of per-Gaussian time tokens; and
performing a cross-attention operation between the per-Gaussian time tokens and the time embedding for time t.
